(19) United States
(12) Patent Application Publication
(10) Pub. No.: US 2026/0278045 A1
(43) Pub. Date: Sep. 17, 2026

(54) SPDX LICENSE EXPRESSION CONSTRUCTION USING LLM

(71) Applicant: Oracle International Corporation, Redwood Shores, CA (US)

(72) Inventors: Enrico Staiano, Zurich (CH); Alexandra Fritzen, Bassersdorf (CH); Matthias Brantner, Sunnyvale, CA (US)

(21) Appl. No.: 19/081,454

(22) Filed: Mar. 17, 2025

(51) Int. Cl. G06F 21/10; G06F 40/166

(52) U.S. Cl. CPC G06F 21/1075; G06F 40/166

(57) ABSTRACT

Here is prompt engineering for a large language model (LLM) that inferentially generates a formal license expression from many license files in a software repository. A computer loads multiple software licenses from many license text files that each can contain a software license that can contain a license identifier. Many original license chunks are generated by splitting each software license into license chunk(s) that do not exceed a predefined chunk size. From the original license chunks are selected multiple chunks that contain at least one expected string. A linguistic prompt is generated that contains the selected license chunks. From the linguistic prompt, the LLM inferentially generates a license expression and a natural language explanation of the expression.

### FIELD OF THE DISCLOSURE

This disclosure relates to prompt engineering for a large language model (LLM) that inferentially generates a formal license expression from many license files in a software repository.

### BACKGROUND

A software license is a legal agreement that defines the terms under which software can be used, modified, and distributed. It is a contract between the copyright holder (the licensor) and the person or organization using the software (the licensee). Without a license, using software would generally be considered copyright infringement. A software license grants permissions by specifying what the licensee is allowed to do with the software. A license may permit or deny some or all usage activities such as running the software for its intended purpose, making copies of the software, changing the software's source code, and sharing the software with others.

A software license may impose restrictions, which are what the licensee is not allowed to do, such as using the software in ways not explicitly permitted, sublicensing the software under different terms, or reverse engineering the software. A license may impose conditions on the licensee, such as including copyright notices in distributed copies, making source code available for modified versions, and paying a license fee.

Software licenses vary widely, but there are some common categories. A permissive license (e.g., MIT, BSD, and Apache) grants broad freedoms to use, modify, and distribute the software, even in proprietary (closed-source) products. Typically only attribution is required. A copyleft license (e.g., GPL) requires that, when distributing modified versions of the software, the modified source code should be shared under the same license.

An application codebase or a software repository may aggregate software components from multiple software vendors. A license expression is a structured string that describes the licensing terms under which software or other material is distributed. A license expression is a way to concisely and unambiguously specify which licenses apply and how they apply. A license expression provides a clear and unambiguous way to communicate licensing terms in a way that can be automatically parsed by software tools, making it easier to manage and track licenses. For compliance, a license expression can help a user understand their rights and obligations when using software. System Package Data Exchange (SPDX®) publishes a registry of the most popular software licenses and their unique identifiers such as for incorporation by reference into a source file of a software application.

### BRIEF DESCRIPTION OF THE DRAWINGS

In the drawings:

FIG. 1 is a block diagram that depicts an example computer that hosts and operates a large language model (LLM) that inferentially generates an inferred license expression from many license text files in a software repository or in a codebase of a software application;

FIG. 2 is a flow diagram that depicts an example generative computer process for hosting and operating an LLM that inferentially generates an inferred license expression from many license text files in a software repository or in a codebase of a software application;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

This disclosure relates to prompt engineering for a large language model (LLM) that inferentially generates a formal license expression from many license files in a software repository. In an embodiment, some license semantics are predefined by System Package Data Exchange (SPDX®), such as license identifiers that are standardized abbreviation used to uniquely identify software licenses. A license expression of a software repository is a way to accurately represent the licensing terms of the entire repository, considering also relationships between licenses. A license expression could be a single license identifier, a license identifier combined with a license exception, or some combination of many license identifiers and exceptions constructed using a small set of defined operators (i.e., AND, OR, WITH and +). The information regarding how to combine the licenses of the repository to construct the license expression is usually present in some files of the repository such as in a README or a LICENSE file. However, manual inspection of the files of the repository to retrieve this information can be very time-consuming. In addition, the relevant licensing information is often presented in an unstructured manner and might also be scattered in various files.

The objective of this approach is to automatically construct the license expression of a software repository. The approach takes as input the software repository and the set of licenses contained in it, and returns the license expression. The approach leverages the set of licenses present in the repository and the locations (i.e., paths within the repository) of the license files. The set of licenses will be provided to an LLM that is specially operated according to innovative prompt engineering. In relevant portions of the repository files, the LLM inferentially (i.e. learned) discovers information on how to combine the licenses. Herein is a natural language processing (NLP) pipeline that may have any of the following example stages 1-6. Based on heuristics herein, stage 1 discovers and retrieves relevant files from a software repository. For acceleration, stage 1 retrieves only the relevant small subset of files, even if most of the files in the repository do not contain a license.

Herein is innovative preprocessing of software licenses in the discovered license files. Preprocessing may entail extraction, truncating, and loading of software licenses into volatile memory in stage 2. For acceleration and increased inferential accuracy as discussed later herein, truncation may be extreme, such as loading only the first twenty lines of text of a software license. For increased inferential accuracy, uniform resource locators (URLs) are noisy and removed from software licenses.

Herein is innovative filtration of portions of software licenses. A software license consists mostly or entirely of natural language (NL) text that is prose consisting primarily of natural paragraphs and natural sentences. Despite extreme truncation, each software license is logically segmented into fixed-size chunks that are tiny such as, for example, a few words or very few sentences in stage 3. For acceleration and increased inferential accuracy, chunks are filtered using keywords that can include wildcards in stage 4. This filtration selects and retains a mix of chunks that contain a license identifier as discussed later herein or that instead contain prose that expressly discusses licensing.

Stage 5 generates an innovative linguistic prompt that increases the speed and accuracy of the generative LLM in stage 6. The set of licenses and the selected files chunks are placed into a structured prompt in stage 5, which is then provided as novel input to the generative LLM in stage 6. The prompt contains also some fixed guidelines about when to use different operators (e.g. AND, OR, WITH and +) in the license expression. In an embodiment, user confidence in the inferred license expression is increased by the LLM inferentially generating a NL explanation of the license expression.

### 1.0 Example Expression Generation Computer

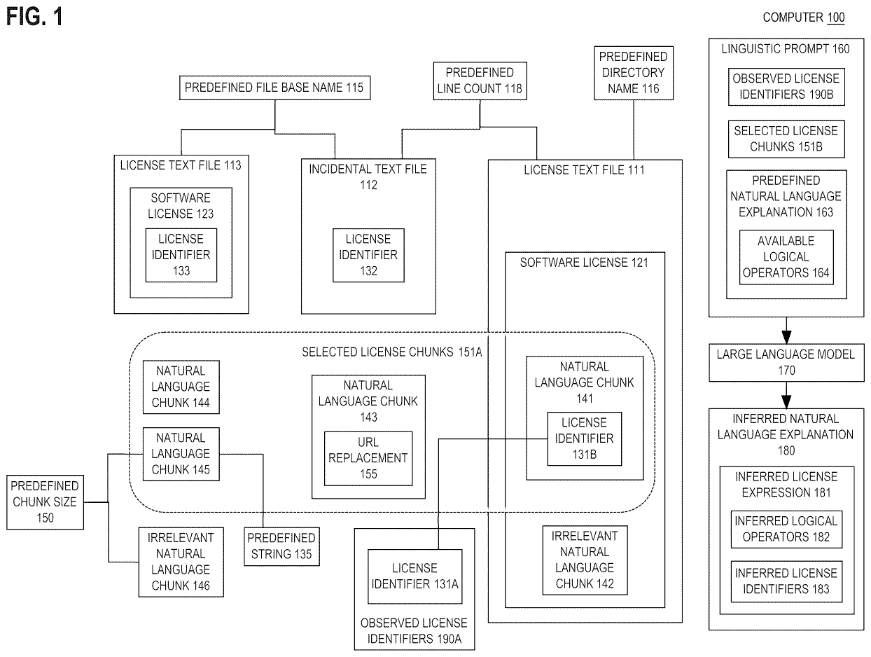

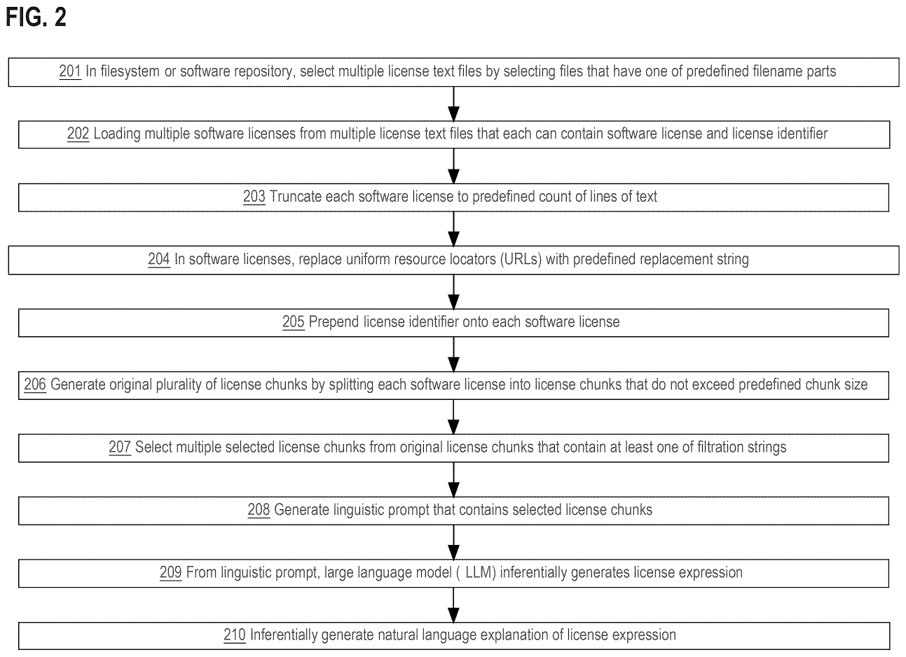

FIG. 1 is a block diagram that depicts computer 100 that hosts and operates large language model (LLM) 170 that inferentially generates inferred license expression 181 from many text files 111-113 in a software repository or in a codebase of a software application. Computer 100 may be one or more computers such as a virtual machine, a blade or other rack server, or a mainframe. All of the components shown in FIG. 1 are stored or generated in volatile or nonvolatile storage in computer 100. In an embodiment, all of the components shown in FIG. 1 are stored or generated in volatile memory, except that data structures 111-113, 121, and 123 are truncated during loading as discussed later for step 203 in FIG. 2. That is, data structures 111-113, 121, and 123 may be truncated in volatile memory and not truncated on disk.

Computer 100 linguistically and semantically analyzes text files 111-113, including in learned ways by LLM 170. Computer 100 operates a processing pipeline that consists of a sequence of processing stages that are: 1) license discovery, 2) license loading with truncation, 3) license segmentation, 4) segment filtration, 5) prompt generation, and 6) generative inference by LLM 170. The output from the processing pipeline is an inference by LLM 170, and this inference contains inferred license expression 181. In an embodiment, the input to the processing pipeline is a uniform resource locator (URL) of a software repository or an URL of a codebase of a software application.

Speed and accuracy of the processing pipeline and of components 170 and 180-183 is increased by above pipeline stages (1)-(5) as follows. Stages (1)-(4) are referred to herein as preprocessing. Stages (5)-(6) are referred to herein as natural language (NL) processing (NLP). Preprocessing is as follows.

### 1.1 Hierarchy of Directories

In an embodiment, the software repository is a git repository that is a version control repository that operates similar to a filesystem. Likewise, a codebase of an application may be operated similar to a filesystem. In a Java embodiment, a class path may define the codebase as consisting of multiple directories and archive files in, for example, multiple filesystems. Even if multiple filesystems are involved, these are analyzed within the context of a single codebase or single software repository. For demonstration, examples herein may be based on operating a git repository as a filesystem.

Herein, a software repository contains a hierarchical arrangement of file directories, including exactly one root directory and a sequence of additional directory levels, each consisting of zero or more files. In the following example directory hierarchy, the period (i.e. ‘.’) is the root directory. Because the period is relative (i.e. not absolute) in a repository or filesystem, the root directory of the repository usually is not the root directory of an operating system (OS) filesystem that contains the repository. In a Java embodiment, the repository root directory may be the root directory in a Java archive (jar) file. The following is the example directory hierarchy in a repository.

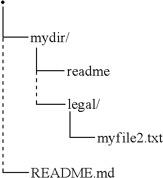

Every file in the software repository has a respective filename that is a string that consists of two filename substrings that are exactly one file base name and zero or one filename extension. For example: a) README.md is a filename; b) README is a file base name; and c) .md is a filename extension. Herein, filenames and their parts and directory names are case insensitive.

In the above example directory hierarchy, computer 100 may discover text files 112-113 based on their filenames as follows. Computer 100 contains multiple predefined file base names, including predefined file base name 115. Anywhere in the directory hierarchy, each file whose file base name is one of the predefined file base names then, herein, that file is a license file or an incidental file. Herein, a license file contains a software license, and an incidental file contains a license identifier of a software license but does not contain the software license. Herein, a file may consist of text content or binary content, and a file that consists solely of text is referred to as a text file, such as text files 111-113. An embodiment may have predefined file base names such as NOTICE, COPY, COPYING, PATENT, LICENSE, COPYRIGHT, and README.

For example: a) README may be predefined file base name 115; and b) readme and README.md may be respective text files 112-113. Each of license text files 111 and 113 contains exactly one software license. For example, license text files 111 and 113 contain respective software licenses 121 and 123. Each of software licenses 121 and 123 may contain: a) prose that is NL consisting of multiple natural paragraphs, each consisting of multiple natural sentences, each consisting of multiple natural words and optionally b) markup tags that are not NL. Incidental text file 112 does not contain a software license but does contain license identifier 132 that identifies a software license.

In the above example directory hierarchy, mydir is a directory that is a subdirectory of the repository root directory. Computer 100 contains multiple predefined directory names, including predefined directory name 116. Anywhere in the directory hierarchy, each directory whose directory name is one of the predefined directory names then, herein, that directory is a license directory. Herein, any text file in a license directory is a license text file, such as license text file 111. An embodiment may have predefined directory names such as ‘.’ (i.e. period, i.e. the repository root), LEGAL, LICENSE, and LICENSES, usually lowercase but case insensitive. For example, legal may be predefined directory name 116.

Computer 100 may discover license text files in a git repository by recursive descent in the repository directory hierarchy. The following is an example git ls-tree command that a linux shell may accept and execute to list unique paths, relative to the repository root, of all files and directories in the repository, with one relative path per line of text in the command output. License text files can be discovered in the output of the following example git ls-tree command by detecting paths that match any of the predefined file base names and predefined directory names.
git ls-tree HEAD-t

### 1.2 Software License in Text File

Herein, each license text file is associated with exactly one respective license identifier that is a non-NL string. For example, LGPL−3.0-or-later is the license identifier for GNU Lesser General Public License v3.0+. If two license text files contain copies of a same software license, then both license text files are associated with a same license identifier.

Depending on the scenario: a) a license text file originally contains its license identifier; b) a license text file can be assigned the license identifier contained in another license text file when both files are in a same directory; or c) the directory hierarchy is climbed (i.e. traversed toward the root directory) incrementally until a license text file is found that contains a license identifier. In that way, every license text file is assigned a license identifier.

Each text file is processed as follows. Predefined line count 118 is a maximum count of text lines to load into volatile memory from the beginning of the license text file. To conserve time and space, additional lines in the license text file are not loaded. Thus in volatile memory, each of software licenses 121 and 123 is truncated and generally has a same count of text lines. In the volatile memory, the license identifier associated with the text file is prepended onto the truncated text file. Thus, text files 111-113 contain respective license identifiers 131B and 132-133. For example, license text files in a same directory are likely to have a same prepended license identifier. In an embodiment, predefined line count 118 does not exceed twenty lines. Incidental text file 112 is truncated and loaded into volatile memory in the same way.

### 1.3 License Fragmentation

Predefined chunk size 150 is a count of bytes, characters, lexical tokens, or natural words. Each software license is logically segmented into NL chunks that do not exceed predefined chunk size 150. That is, each software license is decomposed into a sequence of NL chunks that all have a same fixed size except that the last NL chunk is smaller. For example, software license 121 consists of NL chunks 141-142. Due to the above prepending, the first NL chunk in each software license is guaranteed to contain the license identifier of the software license. Incidental text file 112 is decomposed into single NL chunk 143 in this example.

Computer 100 contains filtration strings 135 and 190A. These are two kinds of filtration strings herein. Predefined string 135 is an originally predefined string that was defined before the license text files were discovered. Originally predefined strings may contain a wild card (e.g. ‘*’, asterisk) that can match any substring. An embodiment may contain originally predefined strings such as licens* and licence*. Observed license identifiers 190A are all of the distinct prepended license identifiers discussed above, including license identifier 131A. Redundantly shown license identifiers 131A-B are a same single license identifier as discussed elsewhere herein.

Selected license chunks 151A are NL chunks 141 and 143-145, which are all of the NL chunks that contain any filtration string. Because every software license contains a first NL chunk that contains a predefined license identifier, selected license chunks 151A are guaranteed to contain at least one NL chunk from each software license. For example, selected license chunks 151A contains multiple NL chunks 144-145 from license text file 111 but only one NL chunk 143 from incidental text file 112 in this example. In other examples, an incidental text file may contain a mix of NL chunks that do and do not contain license identifiers and there may be many incidental text files.

### 1.4 Inferential Generation of License Expression

Irrelevant NL chunks 142 and 146 matched none of the filtration strings and are excluded from selected license chunks 151A. The set of selected license chunks is demonstratively redundantly shown as selected license chunks 151A-B. Selected license chunks 151A are concatenated and inserted as selected license chunks 151B into linguistic prompt 160 that is text that computer 100 generates and that large language model (LLM) 170 accepts as a whole input. In linguistic prompt 160, data components 151B and 190B are respective copies of data components 151A and 190A as discussed elsewhere herein.

LLM 170 inferentially (i.e. learned) semantically analyzes the content of linguistic prompt 160 to inferentially generate inferred license expression 181 that formally and compactly defines the combined licensing requirements of the software repository. For example, different portions of content in the software repository may have different respective software licenses, and LLM 160 already supervised learned how to integrate and deduplicate the many copies of several software licenses in various training software repositories.

Linguistic prompt 160 consists of data and metadata. Selected license chunks 151B is data that is specific to the current software repository. Predefined NL explanation 163 is metadata that is reused for any software repository. Predefined NL explanation 163 is prose (i.e. NL) that increases the accuracy of inferred license expression 181 by: a) articulating the goal of generating inferred license expression 181 and b) enumerating available logical operators 164 and explains how they can be used to combine multiple software licenses or to qualify (e.g. select an optional extension or variance to) a software license as discussed later herein.

Example available logical operators 164 are: a) binary operators such as conjunction and disjunction, b) grouping operators to override operator precedence, and c) various unary operators. Discussed herein is the following example inferred logical expression 181.
(GPL−2.0-or-later WITH Classpath-exception-2.0) AND (MIT OR Apache-2.0) AND BSD-3-Clause AND CC-BY-4.0 AND LGPL−2.1-or-later AND GFDL−1.1-only

In the above example inferred logical expression 181 are inferred logical operators 182 that in this example are:), (OR, AND, and WITH. In the above example inferred logical expression 181 are inferred license identifiers 183 that in this example are: MIT, Apache-2.0, CC-BY-4.0, BSD-3-Clause, GPL−2.0-or-later, LGPL−2.1-or-later, and GFDL−1.1-only.

### 1.5 Inferential Generation of Expression Explanation

In the shown embodiment, the inferentially generated output of LLM 170 is inferred NL explanation 180 that prosaically explains and contains inferred text components 181-183. The following Table 1 is an example inferred NL explanation 180.

(GPL-2.0-or-later WITH Classpath-exception-2.0)
AND (MIT OR Apache-2.0) AND BSD-3-Clause AND CC-
BY-4.0 AND LGPL-2.1-or-later AND GFDL-1.1-only

| Part of Formal | |
|---|---|
| Expression | Part of NL (i.e. informal) Explanation |
| BSD-3-Clause | This software repository is simultaneously subject to |
| AND CC-BY- | multiple licenses. |
| 4.0 | Berkeley Software Distribution is permissive open- |
| | source that allows for the free use, modification, and |
| | distribution of software. |
| | Creative Commons Attribution 4.0 International grants |
| | broad permissions for using and sharing creative works. |
| MIT OR | This is dual licensing. You can choose to use it under |
| Apache-2.0 | either the MIT License or the Apache License 2.0. You |
| | don't have to comply with both licenses at the same |
| | time. |
| GPL-2.0-or- | GNU General Public License version 2.0 or any later |
| later WITH | version of that license. If you distribute software that is |
| Classpath- | based on GPL-covered code, you must also distribute |
| exception-2.0 | your own code under the GPL. |
| | The classpath exception is used for libraries that can be |
| | used with both open-source and proprietary software. |
| | You can combine GPL-covered code with code that is |
| | not under the GPL, without requiring the non-GPL code |
| | to also be licensed under the GPL. |
| GFDL-1.1-only | Although some parts in the software repository would |
| | also work with later license versions, other parts require |
| | this particular version. |
| LGPL-2.1-or- | Although some parts in the software repository would |
| later | also work with earlier license versions, other parts |
| | require a more recent range of versions. |

In above Table 1, WITH is a binary operator that qualifies a software license as having an exception (i.e. variance) such as a permissive carve out. In another example, inferred logical operators 182 does not contain a WITH operator, even though available logical operators 164 does. Computer 100 can persist, commit back into the software repository, or display any of inferred text components 180-183.

### 2.0 Example License Expression Generation Process

FIG. 2 is a flow diagram that depicts an example generative process that computer 100 may perform to operate large language model (LLM) 170 that inferentially generates inferred license expression 181 from many text files 111-113 in a software repository or in a codebase of a software application. The steps of this process are exemplary, which does not mean that all of its steps are implemented in every embodiment.

In the filesystem or software repository, step 201 selects multiple text files 111-113 by selecting files that have one of multiple predefined filename parts such as predefined file base name 115 as discussed earlier herein.

Step 202 loads multiple software licenses 121 and 123 from license text files 111 and 113 that each can contain a software license and a license identifier. In some embodiments, step 202 uses exactly one git checkout command to retrieve all of the license text files, or uses one git checkout command per license text file. In an accelerated embodiment, step 202 uses a git show command instead of git checkout and redirects its standard output (stdout) into volatile memory in computer 100.

Step 203 truncates each of software licenses 121 and 123 to predefined line count 118. For example, step 203 may redirect stdout from git show to a head command that includes predefined line count 118. In that case, steps 202-203 are combined and together issue a single command line, and step 203 may be a sub-step of step 202.

In software licenses 121 and 123, step 204 replaces uniform resource locators (URLs) with predefined replacement 155 that is a string. As discussed earlier herein, each software license is automatically associated with a license identifier. Step 205 prepends license identifiers 131B and 132-133 respectively onto software licenses 121 and 123.

Step 206 generates too many original license chunks 141-146 by splitting each of licenses 121 and 123 into license chunks 141-146 that do not exceed predefined chunk size 150 as discussed earlier herein. Step 207 selects multiple selected license chunks 151A from original license chunks 141-146 that contain at least one filtration string such as filtration strings 135 and 190A as discussed earlier herein.

Step 208 generates linguistic prompt 160 that contains data components 151B and 190B. Redundantly shown observed license identifiers 190A-B are a same plurality of license identifiers.

From linguistic prompt 160, large language model (LLM) 170 inferentially generates inferred license expression 181 in step 209 as discussed earlier herein. If an embodiment implements step 210, then steps 209-210 are combined. In step 210, LLM 170 inferentially generates natural language (NL) explanation 180 for license expression 181 as discussed earlier herein.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

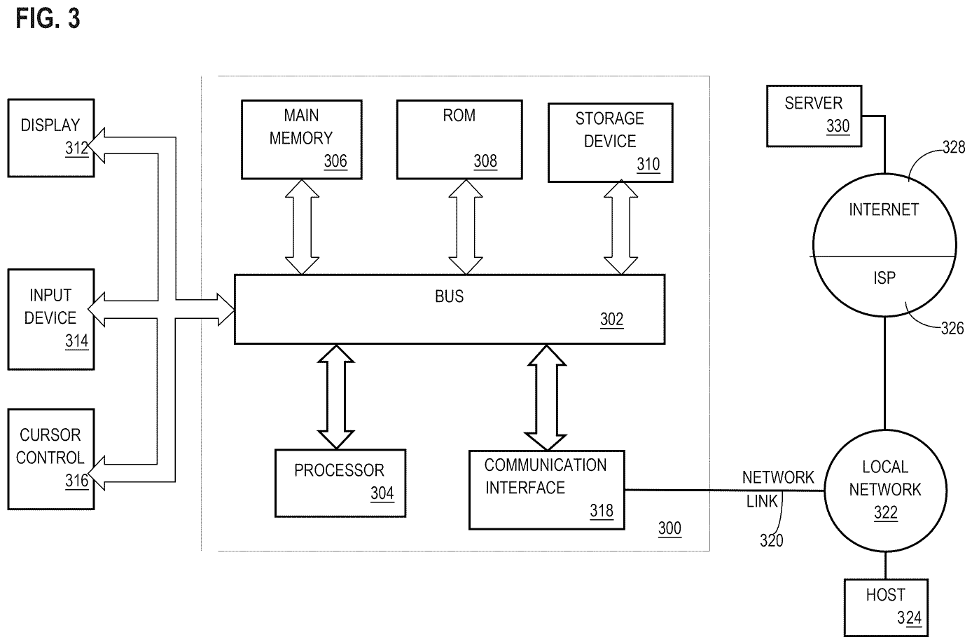

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

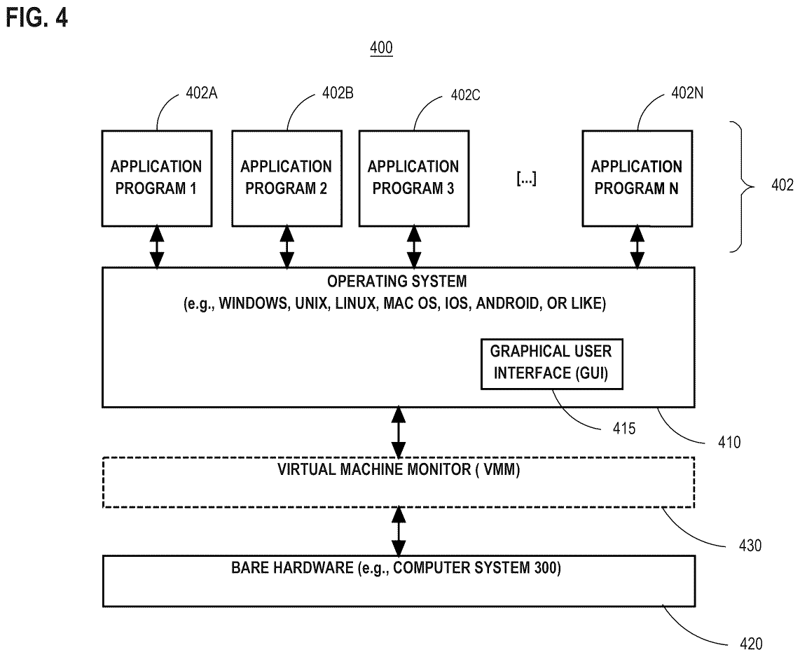

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 400 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N [L−1] columns and N [L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 25; 2(1): 1-18 by Jinwon An et al. PRINCIPAL COMPONENT ANALYSIS

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
truncating each software license of a plurality of software licenses from a plurality of license text files that each can contain a software license that can contain a license identifier by loading at most a predefined count of lines of text from the software license into a memory in a computer;
generating, from the plurality of software licenses in the memory, an original plurality of license chunks by splitting each of the plurality of software licenses into one or more license chunks that do not exceed a predefined chunk size;
selecting a selected plurality of license chunks from the original plurality of license chunks that contain at least one of a plurality of strings;
generating a linguistic prompt that contains the selected plurality of license chunks; and
inferentially generating, by a large language model, a license expression from the linguistic prompt;
wherein the method is performed by the computer.

2. The method of claim 1 wherein the linguistic prompt contains at least one selected from a group consisting of:
the license identifiers in the plurality of software licenses,
a binary logical operator that the license expression contains,
a binary logical operator that the license expression does not contain, and
a natural language explanation of available logical operators that could be included in the license expression.

3. The method of claim 1 wherein said inferentially generating comprises inferentially generating a natural language explanation of the license expression.

4. (canceled)

5. The method of claim 1 wherein the predefined count of lines of text does not exceed twenty.

6. The method of claim 1 wherein the license expression does not contain a particular license identifier in the plurality of software licenses.

7. The method of claim 1 wherein the plurality of strings includes the license identifiers in the plurality of software licenses.

8. The method of claim 1 wherein:
each license text file of the plurality of license text files has a filename;
multiple license text files of the plurality of license text files have a same filename;
the method further comprises in a filesystem or software repository, selecting the plurality of license text files by selecting files that have a filename part in a predefined plurality of filename parts.

9. The method of claim 1 further comprising prepending the license identifier onto each of the plurality of software licenses.

10. The method of claim 1 further comprising in the plurality of software licenses, replacing a plurality of uniform resource locators (URLs) with a predefined replacement string.

11. One or more computer-readable non-transitory media storing instructions that, when executed by a computer, cause:
truncating each software license of a plurality of software licenses from a plurality of license text files that each can contain a software license that can contain a license identifier by loading at most a predefined count of lines of text from the software license into a memory in the computer;
generating, from the plurality of software licenses in the memory, an original plurality of license chunks by splitting each of the plurality of software licenses into one or more license chunks that do not exceed a predefined chunk size;
selecting a selected plurality of license chunks from the original plurality of license chunks that contain at least one of a plurality of strings;
generating a linguistic prompt that contains the selected plurality of license chunks; and
inferentially generating, by a large language model, a license expression from the linguistic prompt.

12. The one or more computer-readable non-transitory media of claim 11 wherein the linguistic prompt contains at least one selected from a group consisting of:
the license identifiers in the plurality of software licenses,
a binary logical operator that the license expression contains,
a binary logical operator that the license expression does not contain, and
a natural language explanation of available logical operators that could be included in the license expression.

13. The one or more computer-readable non-transitory media of claim 11 wherein said inferentially generating comprises inferentially generating a natural language explanation of the license expression.

14. (canceled)

15. The one or more computer-readable non-transitory media of claim 11 wherein the predefined count of lines of text does not exceed twenty.

16. The one or more computer-readable non-transitory media of claim 11 wherein the license expression does not contain a particular license identifier in the plurality of software licenses.

17. The one or more computer-readable non-transitory media of claim 11 wherein the plurality of strings includes the license identifiers in the plurality of software licenses.

18. The one or more computer-readable non-transitory media of claim 11 wherein:
each license text file of the plurality of license text files has a filename;
multiple license text files of the plurality of license text files have a same filename;
the instructions further cause in a filesystem or software repository, selecting the plurality of license text files by selecting files that have a filename part in a predefined plurality of filename parts.

19. The one or more computer-readable non-transitory media of claim 11 wherein the instructions further cause prepending the license identifier onto each of the plurality of software licenses.

20. The one or more computer-readable non-transitory media of claim 11 wherein the instructions further cause in the plurality of software licenses, replacing a plurality of uniform resource locators (URLs) with a predefined replacement string.
